(19) United States
(12) Patent Application Publication
(10) Pub. No.: US 2016/0342167 A1
(43) Pub. Date: Nov. 24, 2016

(54) INTEGRATED CIRCUIT, DYNAMIC VOLTAGE SCALING REGULATOR AND DYNAMIC VOLTAGE SCALING METHOD

(71) Applicant: MediaTek Singapore Pte. Ltd., Singapore (SG)

(72) Inventors: RONG ZHOU, Singapore (SG); KANGLIANG WEI, Singapore (SG); Yipin WU, Singapore (SG)

(21) Appl. No.: 15/145,635

(22) Filed: May 3, 2016

Related U.S. Application Data
(60) Provisional application No. 62/164,133, filed on May 20, 2015.

(51) Int. Cl. G05F 1/56; H02M 1/08

(52) U.S. Cl. CPC G05F 1/56; H02M 1/08; H02M 2001/0009

(57) ABSTRACT

An integrated circuit (IC) is provided. The IC includes an intellectual property (IP) module, and a dynamic voltage scaling regulator capable of providing an output signal to the IP module. The dynamic voltage scaling regulator includes an on-die low drop out (LDO) regulator, a current sensor coupled to the on-die LDO regulator and the

IP module, and a control unit coupled to the current sensor and the on-die LDO regulator. The LDO regulator generates the output signal according to a control signal. The current sensor provides a sensing signal according to a current of the output signal. The control unit provides the control signal to the on-die LDO regulator according to the sensing signal. In response to a variation of the current of the output signal, the on-die LDO regulator adjusts a voltage value of the output signal according to the control signal.

### CROSS REFERENCE TO RELATED APPLICATIONS

This Application claims priority of U.S. Provisional Application No. 62/164,133, filed on May 20, 2015, the entirety of which is incorporated by reference herein.

### BACKGROUND OF THE INVENTION

1. Field of the Invention

The invention relates to a dynamic voltage scaling regulator, and more particularly, to a dynamic voltage scaling regulator of an integrated circuit (IC).

2. Description of the Related Art

Voltage regulators are used in a variety of systems to provide regulated voltage to circuits in the system. Generally, it is desirable to provide stable regulated voltage under a wide variety of loads, and operating frequencies, etc. In other words, a voltage regulator is designed to provide and maintain constant voltage in electrical devices, such as a low dropout (LDO) voltage regulator, which is a DC linear voltage regulator which has a very small input-output differential voltage and relatively low output noise.

In general, a regulator has a drawback in that it cannot respond in time when the loading of the regulator changes from heavy to light, or to there being no load. An output voltage of the regulator is unstable under such circumstance, that is, the output overshoot will last a long time until it is relieved. Furthermore, IR drop caused by the loading of the regulator changing between heavy and light will consume power unnecessarily.

Therefore, a LDO regulator with low IR drop is desired.

### BRIEF SUMMARY OF THE INVENTION

An integrated circuit (IC), a dynamic voltage scaling regulator and a dynamic voltage scaling method are provided. An embodiment of an integrated circuit (IC) is provided. The IC comprises an intellectual property (IP) module, and a dynamic voltage scaling regulator capable of providing an output signal to the IP module. The dynamic voltage scaling regulator comprises an on-die low drop out (LDO) regulator, a current sensor coupled to the on-die LDO regulator and the IP module, and a control unit coupled to the current sensor and the on-die LDO regulator. The LDO regulator generates the output signal according to a control signal. The current sensor provides a sensing signal according to a current of the output signal. The control unit provides the control signal to the on-die LDO regulator according to the sensing signal. In response to a variation of the current of the output signal, the on-die LDO regulator adjusts a voltage value of the output signal according to the control signal.

Furthermore, an embodiment of a dynamic voltage scaling regulator for providing an output signal to an intellectual property (IP) module is provided. The dynamic voltage scaling regulator comprises an on-die low drop out (LDO) regulator, a current sensor, and a control unit. The on-die LDO regulator generates the output signal according to a control signal. The current sensor monitors a current of the output signal to provide a sensing signal. The control unit provides the control signal according to the sensing signal. When the sensing signal indicates that the current of the output signal is smaller than a specific value, the control unit provides the control signal to the on-die LDO regulator, so as to decrease a voltage value of the output signal.

Moreover, an embodiment of a dynamic voltage scaling method is provided. An output signal is provided to an intellectual property (IP) module according to a control signal from a control unit, by an on-die low drop out (LDO) regulator. A current of the output signal is monitored to provide a sensing signal for indicating a variation of the current of the output signal, by a current sensor. In response to the variation of the current of the output signal, a voltage value of the output signal is scaled.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an integrated circuit (IC) according to an embodiment of the invention;

FIG. 2A shows an example illustrating a power delivery network for the output signal Sout of FIG. 1;

FIG. 2B shows an example illustrating a current value of the output signal Sout in the terminal N1 of FIG. 2, and the current value of the output signal Sout is sensed by the current sensor of FIG. 1;

FIG. 2C shows an example illustrating a voltage value of the output signal Sout in the terminal N1 of FIG. 2A, and the voltage value of the output signal Sout is provided by the on-die LDO regulator of FIG. 1;

FIG. 2D shows an example illustrating a voltage value of the output signal Sout in the terminal N2 of FIG. 2A, and the voltage value of the output signal Sout is received by the IP module of FIG. 2A;

FIG. 3A shows another example illustrating a current value of the output signal Sout in the terminal N1 of FIG. 2A, and the current value of the output signal Sout is sensed by the current sensor of FIG. 1;

FIG. 3B shows another example illustrating a voltage value of the output signal Sout in the terminal N1 of FIG. 2A, and the voltage value of the output signal Sout is provided by the on-die LDO regulator of FIG. 1;

FIG. 4 shows another example illustrating a voltage value of the output signal Sout in the terminal N1 of FIG. 2A, and the voltage value of the output signal Sout is provided by the on-die LDO regulator of FIG. 1; and

FIG. 5 shows a dynamic voltage scaling method for an integrated circuit, and the integrated circuit comprises a dynamic voltage scaling regulator (e.g. 110 of FIG. 1) and an IP module (e.g. 150 of FIG. 1).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

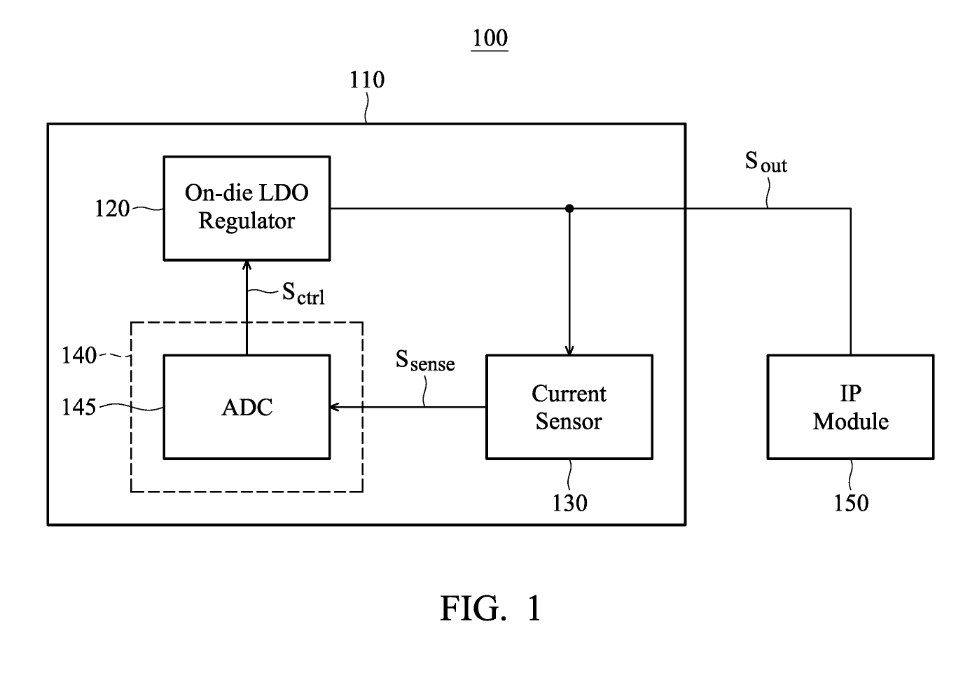

FIG. 1 shows an integrated circuit (IC) 100 according to an embodiment of the invention. The IC 100 comprises at least one dynamic voltage scaling regulator 110 and at least one intellectual property (IP) module 150. The dynamic voltage scaling regulator 110 is capable of providing an output signal Sout to the IP module 150 as a supply voltage of the IP module 150. It should be noted that the dynamic voltage scaling regulator 110 and the IP module 150 are implemented in a single chip. Furthermore, the IP module 150 may be a function module (e.g. a processor, GPU, modem, etc.) or a memory module (e.g. RAM, ROM, etc.). In other embodiments, the IC comprises a plurality of dynamic voltage scaling regulators 110 and a plurality of IP modules 150 corresponding to the dynamic voltage scaling regulators 110, wherein each dynamic voltage scaling regulator 110 is capable of providing an output signal Sout to the corresponding IP module 150 as a supply voltage of the corresponding IP module 150. The dynamic voltage scaling regulator 110 comprises an on-die low drop out (LDO) regulator 120, a current sensor 130 and a control unit 140. The on-die LDO regulator 120 generates the output signal Sout according to a control signal Sctrl from the control unit 140, and a voltage value of the output signal Sout is determined according to the control signal Sctrl. The current sensor 130 is coupled to the on-die LDO regulator 120 and the IP module 150. The current sensor 130 is capable of sensing/monitoring a current value of the output signal Sout and providing a sensing signal Ssense to the control unit 140. In the embodiment, the sensing signal Ssense indicates a variation of the current value of the output signal Sout. According to the sensing signal Ssense, the control unit 140 provides the control signal Sctrl to the on-die LDO regulator 120, so as to adjust the voltage value of the output signal Sout in response to the sensed variation of the current value of the output signal Sout. In the embodiment, the sensing signal Ssense is an analog signal, and the control unit 140 comprises an analog-to-digital converter (ADC) 145 that is capable of converting the sensing signal S sense into a control signal Sctrl. The control signal Sctrl is a digital signal with N bits, and the bit number of the control signal Sctrl is determined according to actual applications. For example, the voltage values of the output signal Sout that can be output are increased as the bit number of the control signal Sctrl is increased.

In FIG. 1, the on-die LDO regulator 120 provides the output signal Sout to the IP module 150 as a supply voltage of the IP module 150. Thus, a current value of the output signal Sout is a loading current corresponding to the IP module 150. If the sensing signal Ssense indicates that the current value of the output signal Sout is decreased, the control unit 140 determines that power consumption of the IP module 150 is decreased. Thus, the control unit 140 provides the control signal Sctrl to the on-die regulator 120, so as to decrease the voltage value of the output signal Sout. Conversely, if the sensing signal Ssense indicates that the current value of the output signal Sout is increased, the control unit 140 determines that power consumption of the IP module 150 is increased. Thus, the control unit 140 provides the control signal Sctrl to the on-die regulator 120, so as to increase the voltage value of the output signal Sout. By dynamically scaling/adjusting a voltage value of the output signal Sout according to the sensed current value of the output signal Sout, IR drop is decreased, thereby decreasing power dissipation of the IC 100.

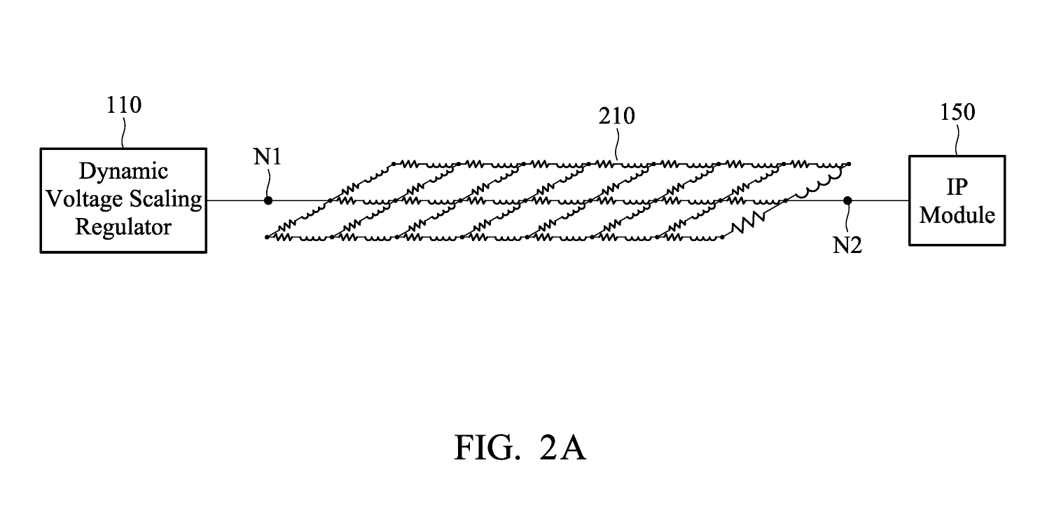

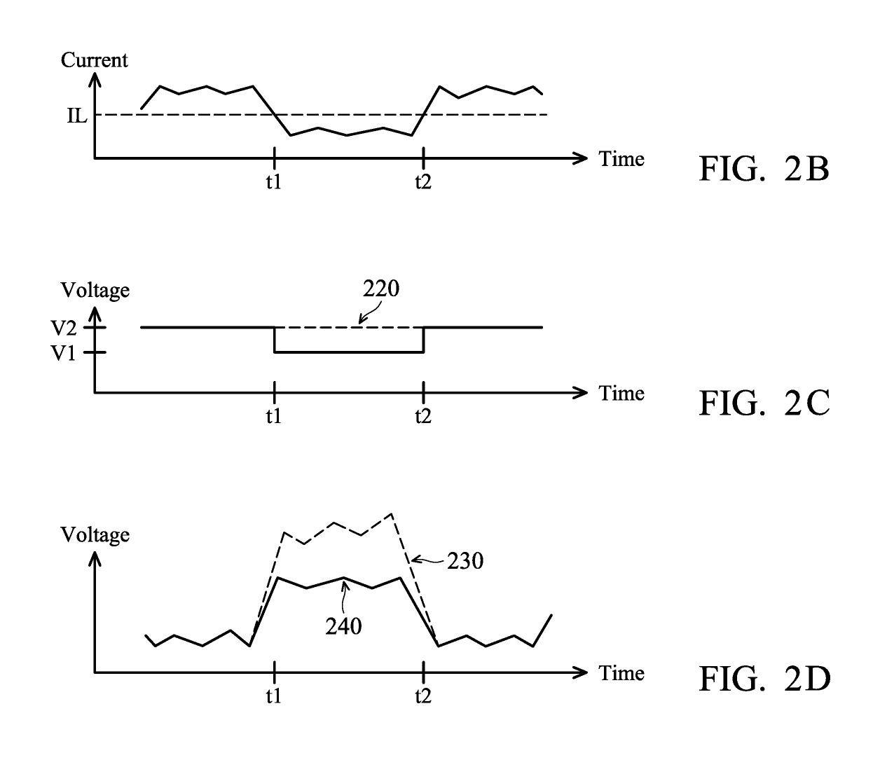

FIG. 2A shows an example illustrating a power delivery network 210 for the output signal Sout of FIG. 1. In FIG. 2A, the dynamic voltage scaling regulator 110 provides the output signal Sout to the IP module 150 via the power delivery network 210. The power delivery network 210 is coupled between a terminal N1 and a terminal N2, wherein the terminal N1 is an output terminal of the dynamic voltage scaling regulator 110, and the terminal N2 is an input terminal of the IP module 150. The power delivery network 210 is formed by a plurality of transmission traces between the terminal N1 of the dynamic voltage scaling regulator 110 and the terminal N2 of the IP module 150.

FIG. 2B shows an example illustrating a current value of the output signal Sout in the terminal N1 of FIG. 2, and the current value of the output signal Sout is sensed by the current sensor 130 of FIG. 1. Furthermore, FIG. 2C shows an example illustrating a voltage value of the output signal Sout in the terminal N1 of FIG. 2A, and the voltage value of the output signal Sout is provided by the on-die LDO regulator 120 of FIG. 1. Moreover, FIG. 2D shows an example illustrating a voltage value of the output signal Sout in the terminal N2 of FIG. 2A, and the voltage value of the output signal Sout is received by the IP module 150 of FIG. 2A. Compared with the voltage value of the output signal Sout of the terminal N1 in FIG. 2C, IR drop of the voltage value of the output signal Sout in the output terminal N2 is caused by the power delivery network 210. Referring to FIGS. 2A-2D together, when the dynamic voltage scaling regulator 110 monitors that the current value of the output signal Sout in the terminal N1 is smaller than a specific current value IL at time point t1, the dynamic voltage scaling regulator 110 decreases the voltage value of the output signal Sout from V2 to V1. When the dynamic voltage scaling regulator 110 monitors that the current value of the output signal Sout in the terminal N1 is larger than the specific current value IL at time point t2, the dynamic voltage scaling regulator 110 recovers the voltage value of the output signal Sout from V1 to V2. Compared with a conventional LDO regulator that provides an output signal with a fixed voltage value (as shown in label 220 of FIG. 2C), the dynamic voltage scaling regulator 110 of FIG. 2A can provide an output signal with a scaling voltage value corresponding to a loading current. Thus, IR drop of the output signal with the scaling voltage value caused by the power delivery network 210 (as shown in label 240 of FIG. 2D) is smaller than IR drop of the output signal with the fixed voltage value caused by the power delivery network 210 (as shown in label 230 of FIG. 2D).

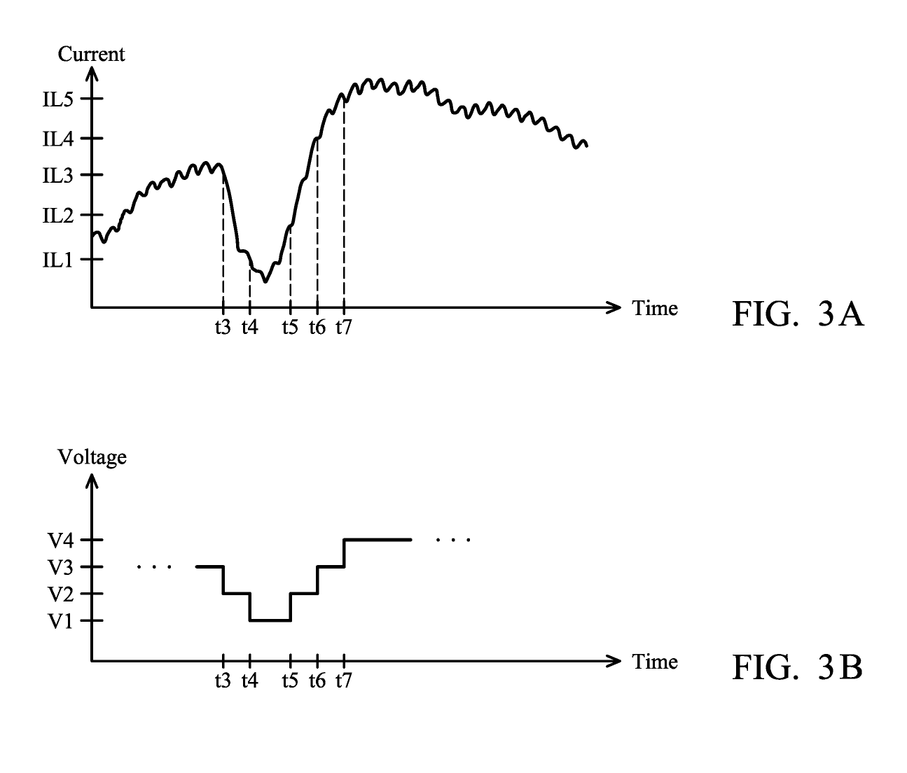

FIG. 3A shows another example illustrating a current value of the output signal Sout in the terminal N1 of FIG. 2A, and the current value of the output signal Sout is sensed by the current sensor 130 of FIG. 1. Furthermore, FIG. 3B shows another example illustrating a voltage value of the output signal Sout in the terminal N1 of FIG. 2A, and the voltage value of the output signal Sout is provided by the on-die LDO regulator 120 of FIG. 1. In the embodiment, more voltage values are provided for the output signal Sout according to the variations of the current value of the output signal Sout. Referring to 3A-3B together, if the dynamic voltage scaling regulator 110 monitors that the current value of the output signal Sout in the terminal N1 is smaller than a current value IL3 at time point t3, the dynamic voltage scaling regulator 110 changes the voltage value of the output signal Sout from V3 to V2. If the dynamic voltage scaling regulator 110 monitors that the current value of the output signal Sout in the terminal N1 is smaller than a current value IL1 at time point t4, the dynamic voltage scaling regulator 110 changes the voltage value of the output signal Sout from V2 to V1. If the dynamic voltage scaling regulator 110 monitors that the current value of the output signal Sout in the terminal N1 is larger than a current value IL2 at time point t5, the dynamic voltage scaling regulator 110 changes the voltage value of the output signal Sout from V1 to V2. If the dynamic voltage scaling regulator 110 monitors that the current value of the output signal Sout in the terminal N1 is larger than a current value IL4 at time point t6, the dynamic voltage scaling regulator 110 changes the voltage value of the output signal Sout from V2 to V3. If the dynamic voltage scaling regulator 110 monitors that the current value of the output signal Sout in the terminal N1 is larger than a current value IL5 at time point t7, the dynamic voltage scaling regulator 110 changes the voltage value of the output signal Sout from V3 to V4. Therefore, the dynamic voltage scaling regulator 110 can dynamically scale the voltage value of output signal Sout in response to a variation of the current value of the output signal Sout, and the variation of the current value of the output signal Sout is caused by a loading of the dynamic voltage scaling regulator 110.

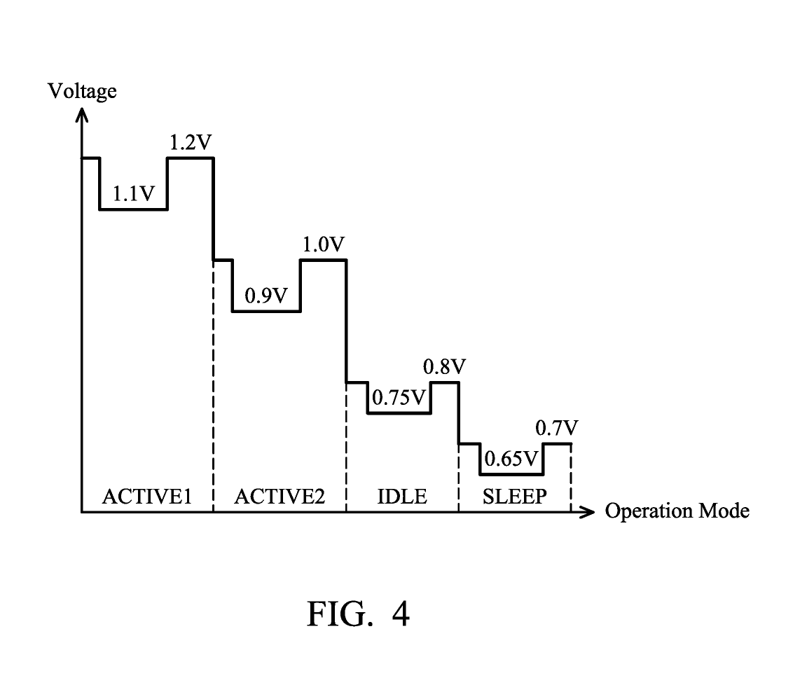

FIG. 4 shows another example illustrating a voltage value of the output signal Sout in the terminal N1 of FIG. 2A, and the voltage value of the output signal Sout is provided by the on-die LDO regulator 120 of FIG. 1. In the embodiment, the dynamic voltage scaling regulator 110 can provide the output signal Sout with at least two voltage values at each operation mode, such as a first active mode ACTIVE1, a second active mode ACTIVE2, an idle mode IDLE, and a sleep mode SLEEP. For example, if the dynamic voltage scaling regulator 110 monitors that the current value of the output signal Sout is larger than a current value Iact1, the dynamic voltage scaling regulator 110 enters a first active mode ACTIVE1, and controls the voltage value of the output signal Sout to switch between 1.1V and 1.2V according to a variation of the current value of the output signal Sout. If the dynamic voltage scaling regulator 110 monitors that the current value of the output signal Sout is larger than a current value Iact2 and smaller than the current value Iact1, the dynamic voltage scaling regulator 110 enters a second active mode ACTIVE2, and controls the voltage value of the output signal Sout to switch between 0.9V and 1.0V according to a variation of the current value of the output signal Sout. If the dynamic voltage scaling regulator 110 monitors that the current value of the output signal Sout is larger than a current value Iidle and smaller than the current value Iact2, the dynamic voltage scaling regulator 110 enters an idle mode IDLE, and controls the voltage value of the output signal Sout to switch between 0.75V and 0.8V according to a variation of the current value of the output signal Sout. If the dynamic voltage scaling regulator 110 monitors that the current value of the output signal Sout is smaller than the current value Iidle, the dynamic voltage scaling regulator 110 enters a sleep mode SLEEP, and controls the voltage value of the output signal Sout to switch between 0.65V and 0.7V according to a variation of the current value of the output signal Sout.

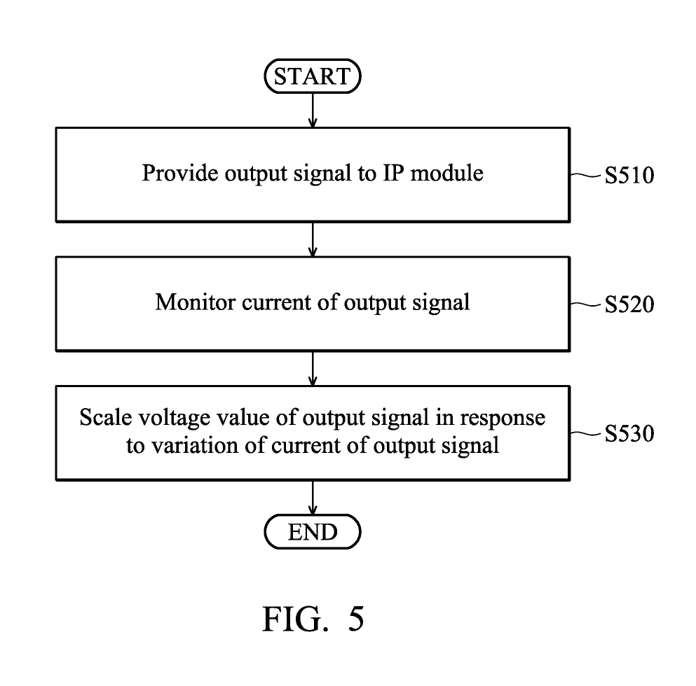

FIG. 5 shows a dynamic voltage scaling method for an integrated circuit, and the integrated circuit comprises a dynamic voltage scaling regulator (e.g. 110 of FIG. 1) and an IP module (e.g. 150 of FIG. 1). First, in step S510, according to a control signal Sctrl, an on-die LDO regulator of the dynamic voltage scaling regulator provides an output signal Sout to the IP module as a supply voltage of the IP module. Next, in step S520, a current sensor of the dynamic voltage scaling regulator monitors/senses a current of the output signal Sout, and provides a sensing signal S sense for indicating a variation of the current of the output signal. Next, in step S530, a control unit of the dynamic voltage scaling regulator receives the sensing signal Ssense, and provides the control signal Sctrl to the on-die LDO regulator, so as to scale the voltage value of the output signal in response to the variation of the current of the output signal.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An integrated circuit (IC), comprising:
an intellectual property (IP) module; and
a dynamic voltage scaling regulator, providing an output signal to the IP module, and comprising:
an on-die low drop out (LDO) regulator, generating the output signal according to a control signal;
a current sensor coupled to the on-die LDO regulator and the IP module, providing a sensing signal according to a current of the output signal; and
a control unit coupled to the current sensor and the on-die LDO regulator, providing the control signal to the on-die LDO regulator according to the sensing signal,
wherein in response to a variation of the current of the output signal, the on-die LDO regulator adjusts a voltage value of the output signal according to the control signal.

2. The integrated circuit as claimed in claim 1, wherein when the sensing signal indicates that the current of the output signal is decreased, the control unit provides the control signal to the on-die LDO regulator, so as to decrease the voltage value of the output signal.

3. The integrated circuit as claimed in claim 1, wherein when the sensing signal indicates that the current of the output signal is increased, the control unit provides the control signal to the on-die LDO regulator, so as to increase the voltage value of the output signal.

4. The integrated circuit as claimed in claim 1, wherein the sensing signal is an analog signal and the control signal is a digital signal, and the control unit is an analog-to-digital converter for converting the analog signal into the digital signal.

5. The integrated circuit as claimed in claim 1, wherein the on-die LDO regulator provides the output signal to the IP module as a supply voltage of the IP module.

6. The integrated circuit as claimed in claim 5, wherein the current of the output signal is a loading current corresponding to the IP module.

7. A dynamic voltage scaling regulator for providing an output signal to an intellectual property (IP) module, comprising:
an on-die low drop out (LDO) regulator, generating the output signal according to a control signal;
a current sensor, monitoring a current of the output signal to provide a sensing signal; and
a control unit, providing the control signal according to the sensing signal,
wherein when the sensing signal indicates that the current of the output signal is smaller than a specific value, the control unit provides the control signal to the on-die LDO regulator, so as to decrease a voltage value of the output signal.

8. The dynamic voltage scaling regulator as claimed in claim 7, wherein when the sensing signal indicates that the current of the output signal is larger than the specific value, the control unit provides the control signal to the on-die LDO regulator, so as to recover the decreased voltage value of the output signal.

9. The dynamic voltage scaling regulator as claimed in claim 7, wherein the dynamic voltage scaling regulator and the IP module are implemented in a single chip.

10. The dynamic voltage scaling regulator as claimed in claim 7, wherein the sensing signal is an analog signal and the control signal is a digital signal, and the control unit is an analog-to-digital converter for converting the analog signal into the digital signal.

11. The dynamic voltage scaling regulator as claimed in claim 7, wherein the on-die LDO regulator provides the output signal to the IP module as a supply voltage of the IP module.

12. The dynamic voltage scaling regulator as claimed in claim 7, wherein the current of the output signal is a loading current corresponding to the IP module.

13. A dynamic voltage scaling method, comprising:
providing an output signal to an intellectual property (IP) module according to a control signal from a control unit, by an on-die low drop out (LDO) regulator;
monitoring a current of the output signal to provide a sensing signal for indicating a variation of the current of the output signal, by a current sensor; and
in response to the variation of the current of the output signal, scaling a voltage value of the output signal.

14. The dynamic voltage scaling method as claimed in claim 13, wherein the step of in response to the variation of the current of the output signal, scaling the voltage value of the output signal further comprises:
decreasing the voltage value of the output signal when the sensing signal indicates that the current of the output signal is decreased; and
increasing the voltage value of the output signal when the sensing signal indicates that the current of the output signal is increased.

15. The dynamic voltage scaling method as claimed in claim 13, wherein the step of in response to the variation of the current of the output signal, scaling the voltage of the output signal further comprises:
providing the control signal to the on-die LDO regulator when the sensing signal indicates that the current of the output signal is smaller than a specific value, by the control unit;
in response to the control signal, decreasing the voltage value of the output signal, by the on-die LDO regulator.

16. The dynamic voltage scaling method as claimed in claim 15, wherein the step of in response to the variation of the current of the output signal, scaling the voltage of the output signal further comprises:
providing the control signal to the on-die LDO regulator when the sensing signal indicates that the current of the output signal is larger than the specific value, by the control unit;
in response to the control signal, recovering the decreased voltage value of the output signal, by the on-die LDO regulator.

17. The dynamic voltage scaling method as claimed in claim 13, wherein the on-die LDO regulator, the current sensor, the control unit, and the IP module are implemented in a single chip.

18. The dynamic voltage scaling method as claimed in claim 13, wherein the sensing signal is an analog signal and the control signal is a digital signal, and the control unit is an analog-to-digital converter for converting the analog signal into the digital signal.

19. The dynamic voltage scaling method as claimed in claim 13, wherein the on-die LDO regulator provides the output signal to the IP module as a supply voltage of the IP module.

20. The dynamic voltage scaling method as claimed in claim 13, wherein the current of the output signal is a loading current corresponding to the IP module.
